(19) United States
(12) Patent Application Publication
(10) Pub. No.: US 2004/0156525 A1
(43) Pub. Date: Aug. 12, 2004

(54) Transducer motor with low thermal modulation

(76) Inventor: Earl Russell Geddes, Novi, MI (US)

Correspondence Address: Earl R. Geddes, 43516 Scenic Lane, Northville, MI, 48167, US

(21) Appl. No.: 10/361,331

(22) Filed: Feb. 10, 2003

(51) Int. Cl. H04R 1/00; H04R 9/06; H04R 11/02

(52) U.S. Cl. 381/400; 381/410

(57) ABSTRACT

A composition for a loudspeakers voice coil wire material that reduces the thermal modulation of the motor force factor due to wire resistance changes with temperature.

### BACKGROUND

1. Field of the Invention

The present invention relates to the use of alternative materials in the wire windings of an electro-acoustic transducer.

2. Description of Prior Art

In high performance audio playback systems it is common practice to operate these devices at high power levels such that the voice coil's operating temperature rises significantly. When this occurs the voice coils resistance rises due to a (normally) positive Temperature Coefficient of Resistance (TCR). This creates a substantial variation in the response characteristics of the transducer, usually of a detrimental nature.

In U.S. Pat. No. 5,664,023 (1997) Button observes that “Designers have adopted copper and aluminum . . . for voice coil windings almost exclusively on the basis of low resistivity at room temperature . . . , and have simply accepted the TCR resistance rise. The potential of utilizing wire material with lower TCR and suitable density, despite higher initial resistivity, has not been recognized heretofore.” Button's patent does a good job of developing an approach “for achieving maximum possible SPL (Sound Pressure Level)”. Button's invention is supreme satisfies his this goal.

One might, however, seek to simply reduce the total resistance variation with temperature, exclusive of its effect on the maximum SPL, in which case another voice coil material may prove to be more advantageous than those found in the prior art.

### OBJECTS AND ADVANTAGES

It is the primary object of this invention to disclose a variety of voice coil alloys whereby the total voice coil resistance change over its operating temperature is minimized. Minimizing the changes in voice coil resistance minimizes the effect of these changes resulting in a loudspeaker system with a preferred sound quality, especially when driven at high output levels.

### DRAWING FIGURES

FIG. 1 shows the frequency response variations of a loudspeaker system made from wire with a high TCR value;

FIG. 2 shows the frequency response of a loudspeaker system made from wire with small amounts of Nickel added;

FIG. 3 shows a table of materials selected for the low TCR;

### SUMMARY

In accordance with the present invention, a material composition for the voice coil windings in an electro-acoustic transducer that lowers its resistance with temperature rise is disclosed.

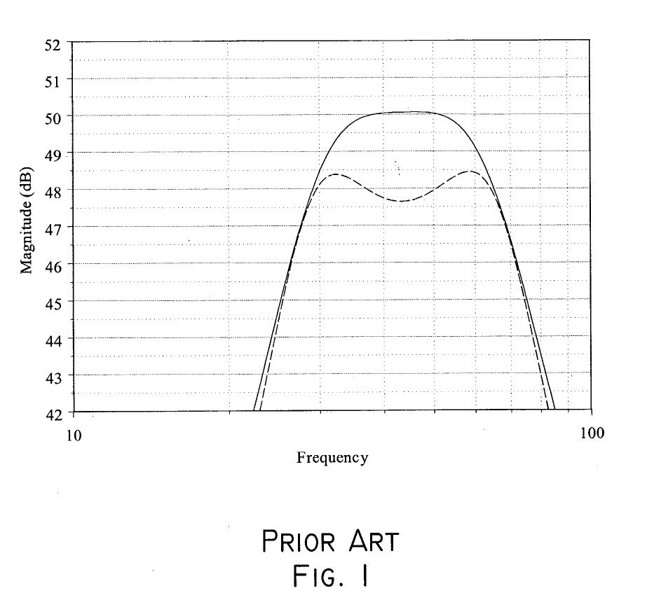

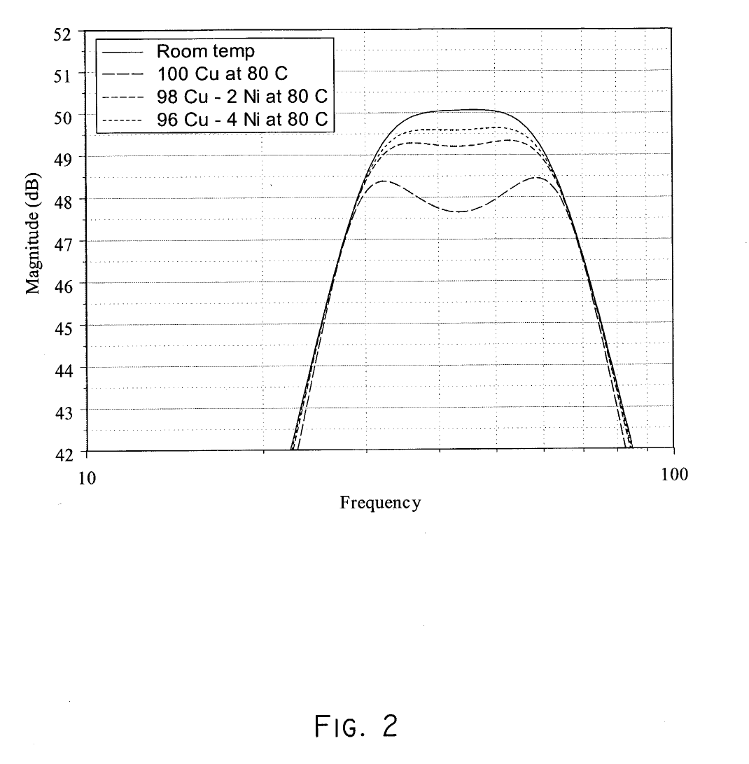

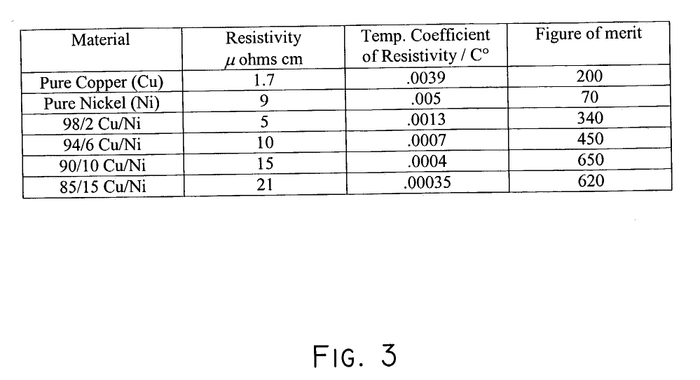

Description FIGS. 1 to 3

FIG. (1) shows a computer simulation of the frequency response for a bandpass single ported enclosure. The upper curve is the response at room temperature and the lower curve is the response of the same system but with the voice coil at the elevated temperature of 100° C. as typically encountered in operation. The degradation of the response as the voice coil heats should be noted.

FIG. (2) shows the predicted response of an identical loudspeaker system with three voice coil materials, pure Copper, 98% Copper-2% Nickel, and 96% Copper-4% Nickel compared with the room temperature response. Clearly the addition of a small percentage of Nickel dramatically reduces the thermal modulation. The improvement increases with the amount of Nickel, however the resistivity also increases, which is undesirable. The best choice—i.e. compromise, appears to be the 2% Nickel alloy since this give good thermal modulation reduction without too much increase in resistivity. This comparison is shown in FIG. (3) where the resistivity, TOC and a figure of merit, (the inverse of the square root of the resistivity and TOC product) are shown for various alloys of wire. (This table does not allow for a precise comparison since only about one significant digit is available from published data for these materials).

The resistivity is not weighted as strongly in the figure of merit as is the TOC since our goal here is to reduce the thermal modulation not the resistance. But since the resistivity does adversely affect a loudspeaker design it should be accounted for. It can be seen that there is an increasing advantage to the Copper Nickel alloys as more Nickel is added up to about 10% Nickel. At 10% the resistivity is probably too high to be useful. The table shows that the resistivity and the TOC go almost hand in hand, the ratios of the changes are very close to one another. This makes for a reasonable rule of thumb for selecting the alloy percentages. The highest amount of nickel which can be reasonably accommodated in a design should be used. This amount will differ substantially from design to design depending mostly on how important the weight of the voice coil is the design requirements. For example, in woofers the weight of the voice coil is not an critical factor, like it can be for tweeters and compression drivers. Since woofers tend to require the most power this is a fortunate result.

Other useful objects and advantages will be apparent to those proficient in the art.

I claim:

1) An electro-acoustic transducer motor structure containing a coil of wire wherein:
said coil windings are fabricated of an alloy selected for its low Temperature Coefficient of Resistance.

2) The coil windings as defined in claim 1 wherein;
said windings are made of an alloy of copper and nickel.

3) The coil windings as defined in claim 2 wherein;
said windings are made of an alloy of copper and nickel wherein the amount of Nickel lies in the range of 1% to 10%.
